(19) United States
(12) Patent Application Publication
(10) Pub. No.: US 2009/0129694 A1
(43) Pub. Date: May 21, 2009

(54) METHOD AND APPARATUS THEREOF FOR ENHANCING DIGITAL IMAGE

(75) Inventors: Ming-Yang WU, Hsin Chu City (TW); Brian Sung, Taipei City (TW); Chi-Chang Yu, Hsin Chu City (TW); Chia-Kai Liang, Hsin-Chu (TW)

Correspondence Address: Muncy, Geissler, Olds & Lowe, PLLC, P.O. BOX 1364, FAIRFAX, VA, 22038-1364, US

(73) Assignee: AVISONIC TECHNOLOGY CORP.

(21) Appl. No.: 12/139,808

(22) Filed: Jun. 16, 2008

(30) Foreign Application Priority Data
Nov. 15, 2007 (TW) 096143161

(51) Int. Cl. G06K 9/40

(52) U.S. Cl. 382/260

(57) ABSTRACT

A method and an apparatus thereof for enhancing a digital image. The method includes the steps of: capturing a pixel data block; determining a searching region and a reference window with the pixel data block serving as a center; dividing the searching region into compared windows each having a size equal to a size of the reference window; sequentially comparing the compared windows to the reference window to determine corresponding weighting values according to compared results; multiplying calculated blocks in the compared windows by the corresponding weighting values of the blocks to obtain weighted blocks; accumulating the weighted blocks to obtain a summed pixel data block; accumulating the weighting values to obtain a summed weighting value; and normalizing the summed pixel data block according to the summed weighting value to obtain an image-enhanced pixel data block.

### BACKGROUND OF THE INVENTION

1. Field of Invention

The invention relates to digital image associated technology, and more particularly to a method and an apparatus for enhancing a digital image.

2. Related Art

Recently, the formats of multimedia become more and more diversified due to the progress of the technology. The image enhancement of a digital image of a digital photograph, a digital display, a digital film or the digital image broadcasting technology is getting more and more emphasized, wherein the noise filtering effect is very important. In the past, many researches for eliminating the noise in the digital image have been made on the Gaussian filtering algorithm, the bilateral filtering algorithm or even the wavelet algorithm, for example.

Some of the above-mentioned algorithms may have the good effect but the high complexity, and thus cannot be easily implemented on the hardware. Thus, the above-mentioned methods for eliminating the noise are mostly implemented by the software in conjunction with a processor with the high computing power. Also, the above-mentioned methods for eliminating the noise have the extremely large computation loading. So, the above-mentioned methods cannot be applied to the product, such as a digital television or a digital camera, for timely outputting the digital images. For example, U.S. Patent Publication No. 20070053477 discloses the use of the wavelet transfer technology to eliminate the noise. However, the wavelet transfer computation is too complicated, so it only can be applied to the static image, such as the computer Tomography image, disclosed in the specification.

U.S. Patent No. 20070177817 discloses a method for eliminating the noise and a digital camera using the same. However, this patent publication adopts the complicated algorithm, and the computer computation has to be inevitably adopted to achieve the complicated algorithm. Otherwise, the patent publication can be applied to the condition of processing the static frame in the digital camera.

Thus, it is necessary to develop a method and an apparatus capable of quickly eliminating the noise on a dynamic frame.

### SUMMARY OF THE INVENTION

It is therefore an object of the invention to provide a method for enhancing a digital image in the hardware with the better noise filtering effect.

Another object of the invention is to provide an apparatus for enhancing a digital image, wherein the hardware request can be reduced, the noise filtering effect can be enhanced, and a block effect on the image can be eliminated.

The invention achieves the above-identified or other objects by providing a method for enhancing a digital image. The method includes the steps of: capturing a pixel data block; determining a searching region and a reference window with the pixel data block serving as a center; dividing the searching region into a plurality of compared windows each having a size the same as a size of the reference window; sequentially comparing the compared windows with the reference window to respectively determine corresponding weighting values according to compared results; multiplying calculated blocks in the compared windows by the corresponding weighting values of the blocks to obtain a plurality of weighted blocks, wherein a position of each of the calculated blocks in the compared windows is the same as a position of the pixel data block in the reference window; accumulating the weighted blocks to obtain a summed pixel data block; accumulating the weighting values to obtain a summed weighting value; and normalizing the summed pixel data block according to the summed weighting value to obtain an image-enhanced pixel data block.

According to the method for enhancing the digital image of the invention, the pixel data block is captured from a memory, and the step of capturing the pixel data block includes: storing the image-enhanced pixel data block to the memory to replace the original pixel data block.

The invention further provides an apparatus for enhancing a digital image. The apparatus includes a memory, a weighting coefficient calculating module, an accumulating module and an averaging module. The memory stores graphic data. The weighting coefficient calculating module is for capturing a reference window from the memory. The reference window includes a pixel data block, and sequentially captures a plurality of compared windows from the memory in a fixed range of the reference window with a position of the graphic data serving as a center, and sequentially comparing the compared windows with the reference window to correspondingly determine a plurality of weighting values of the compared windows. The accumulating module is for accumulating products, which are obtained by multiplying weighted blocks in the captured compared windows by the corresponding weighting values, to obtain a summed pixel data block. A position of each of the weighted blocks in the compared windows is the same as a position of the pixel data block in the reference window. The averaging module is for accumulating the weighting values to obtain a summed weighting value, and normalizing the summed pixel data block according to the summed weighting value to obtain an image-enhanced pixel data block.

The spirit of the invention is to provide the image enhancing algorithm with the block serving as one unit. Compared with the prior art, in which the data is outputted with the pixel serving as one unit, the invention has the data throughput speed, which is several times that of the prior art, per unit time. In addition, the invention has almost the same noise suppressing ability as the prior art having the algorithm with the pixel serving as one unit, and can eliminate the block effect on the image.

Further scope of the applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention.

FIG. 1 is a circuit block diagram showing an apparatus for enhancing a digital image according to an embodiment of the invention.

FIG. 2 is a schematic illustration showing a block definition according to the embodiment of the invention.

FIG. 3 is a schematic illustration showing a standard of asserting a weighting value.

FIGS. 4A to 4C are schematic illustrations showing how a compared window CBK is cut in a fixed range 22.

FIG. 5 is a detailed circuit diagram showing the apparatus for enhancing the digital image according to the embodiment of the invention.

FIG. 6A is a flow chart showing a method for enhancing the digital image according to the embodiment of the invention.

FIG. 6B is a flow chart showing steps 75 to 77 in the method for enhancing the digital image according to the embodiment of the invention.

### DETAILED DESCRIPTION OF THE INVENTION

The present invention will be apparent from the following detailed description, which proceeds with reference to the accompanying drawings, wherein the same references relate to the same elements.

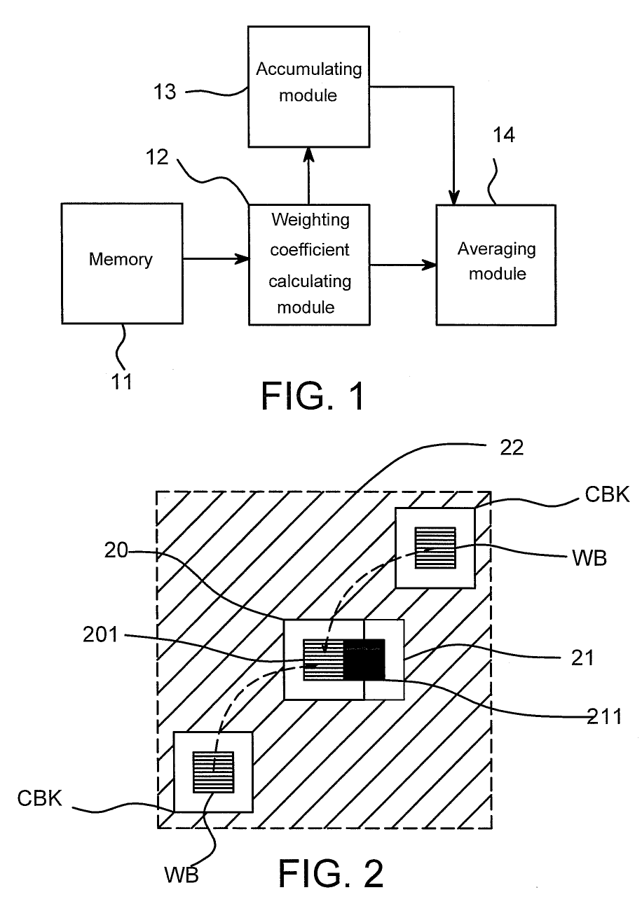

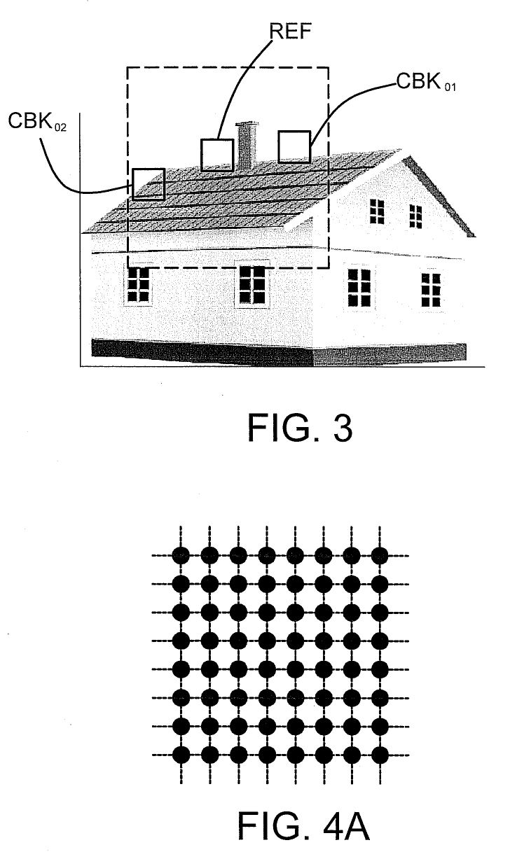

FIG. 1 is a circuit block diagram showing an apparatus for enhancing a digital image according to an embodiment of the invention. Referring to FIG. 1, the apparatus includes a memory 11, a weighting coefficient calculating module 12, an accumulating module 13 and an averaging module 14. The connection relationship of the circuit is shown in the drawing. At first, the memory 11 stores a piece of graphic data. The piece of graphic data may correspond to a complete image or a portion of the complete image. FIG. 2 is a schematic illustration showing a block definition according to the embodiment of the invention. For the sake of illustration, illustrations will be made with reference to FIGS. 1 and 2.

Assume that the memory 11 stores the above-mentioned graphic data and that the image enhancing operation starts to process a pixel data block 201. The weighting coefficient calculating module 12 captures a reference window 20 from the memory 11. In this embodiment, the size of the reference window 20 corresponds to a 5×5 block, and the size of the pixel data block 201 therein corresponds to a 3×3 block. Next, the weighting coefficient calculating module 12 sequentially captures, from the memory 11, a plurality of compared windows CBK each having a size the same as the size of the reference window 20 in a fixed range 22, respectively compares the compared windows CBK with the reference window 20, and determines one corresponding weighting value of each compared window CBK according to the similarity between the compared window CBK and the reference window 20. Generally speaking, when the compared window CBK is more similar to the reference window 20, the corresponding weighting value gets larger.

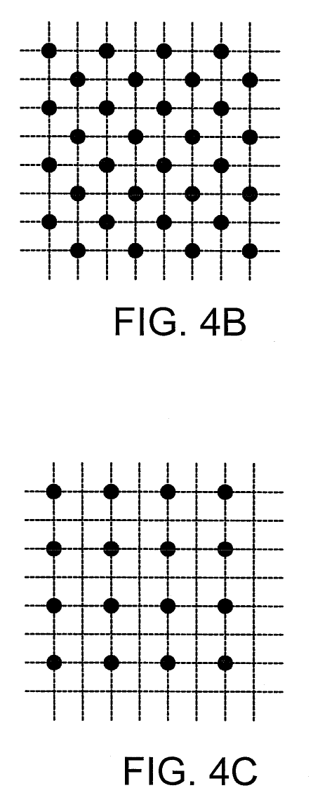

FIG. 3 is a schematic illustration showing a standard of asserting a weighting value. As shown in reference FIG. 3, the reference window is assumed to be a window REF. As shown in FIG. 3, the compared window CBK₀₁ is more similar to the reference window REF, so the weighting value of the compared window CBK₀₁ is larger. The compared window CBK₀₂ is almost different from the reference window REF so the weighting value of the compared window CBK₀₂ is smaller.

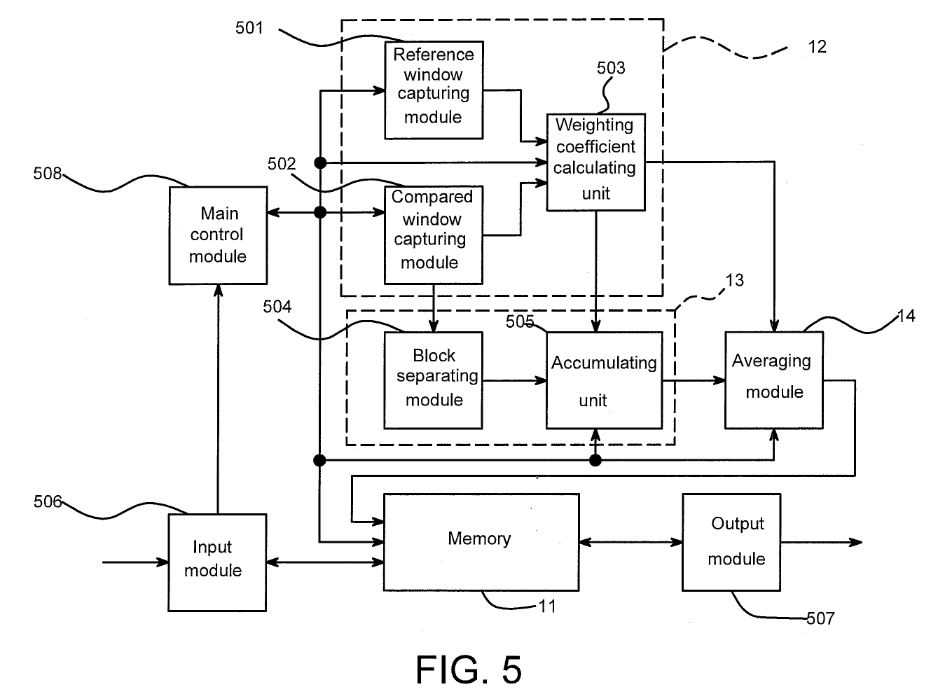

FIGS. 4A to 4C are schematic illustrations showing how the compared window CBK is cut in the fixed range 22. In FIG. 4A, the compared window CBK is captured with each pixel serving as a center. In FIG. 4B, the compared window CBK is captured with each dot of the rhombus array serving as the center. In FIG. 4C, the compared window CBK is captured with each dot of the square of four pixels serving as the center. In FIG. 4C, the compared windows CBK obtained according to the invention embodiment are separated by two pixels. As shown in this embodiment, the compared window CBK may be cut in various manners. One of ordinary skill in the art may flexibly change the interval between the compared windows CBK or the capturing and dividing manners of the compared windows CBK according to different hardware designs.

Meanwhile, the accumulating module 13 accumulates products, each of which is obtained by multiplying each pixel of the weighted block WB in the captured compared window CBK by the weighting value corresponding to the captured compared window CBK. The position of the weighted block WB in the compared window is the same as the position of the pixel data block 201 in the reference window 20. After all the compared windows CBK have been compared with the reference window 20, a summed pixel data block is obtained. The following mathematically equation may be obtained:

$$[ \begin{matrix}{WB}_{0}^{1} & {WB}_{1}^{1} & {WB}_{2}^{1} \\ {WB}_{3}^{1} & {WB}_{4}^{1} & {WB}_{5}^{1} \\ {WB}_{6}^{1} & {WB}_{7}^{1} & {WB}_{8}^{1}\end{matrix} ] {W}^{1} + [ \begin{matrix}{WB}_{0}^{2} & {WB}_{1}^{2} & {WB}_{2}^{2} \\ {WB}_{3}^{2} & {WB}_{4}^{2} & {WB}_{5}^{2} \\ {WB}_{6}^{2} & {WB}_{7}^{2} & {WB}_{8}^{2}\end{matrix} ] {W}^{2} + ... + [ \begin{matrix}{WB}_{0}^{n} & {WB}_{1}^{n} & {WB}_{2}^{n} \\ {WB}_{3}^{n} & {WB}_{4}^{n} & {WB}_{5}^{n} \\ {WB}_{6}^{n} & {WB}_{7}^{n} & {WB}_{8}^{n}\end{matrix} ] {W}^{n} = [ \begin{matrix}{\overline{WB}}_{0} & {\overline{WB}}_{1} & {\overline{WB}}_{2} \\ {\overline{WB}}_{3} & {\overline{WB}}_{4} & {\overline{WB}}_{5} \\ {\overline{WB}}_{6} & {\overline{WB}}_{7} & {\overline{WB}}_{8}\end{matrix} ] , \\ wherein [ \begin{matrix}{\overline{WB}}_{0} & {\overline{WB}}_{1} & {\overline{WB}}_{2} \\ {\overline{WB}}_{3} & {\overline{WB}}_{4} & {\overline{WB}}_{5} \\ {\overline{WB}}_{6} & {\overline{WB}}_{7} & {\overline{WB}}_{8}\end{matrix} ] , \qquad ( Equation 1 )$$

denotes the summed pixel data block, WB₀^{k} to WB₈^{k} denote the pixels in the weighted block WB of the k^{th} compared window, W¹ to Wⁿ respectively denote the corresponding weighting values corresponding to 1^{st} to n^{th} captured compared window CBK. So, W̅B̅ᵢ=WBᵢ¹*W¹+WBᵢ²*W²+ . . . +WBᵢⁿ*Wⁿ, and i=0 to 8.

When the above-mentioned operation is being performed, the averaging module 14 accumulates the weighting values W¹ to Wⁿ to obtain a summed weighting value. After the weighting coefficient calculating module 12 has completely calculated the weighting coefficients of the fixed range 22 and the accumulating module 13 has finished the accumulating operation, the averaging module 14 normalizes the summed pixel data block according to the summed weighting value so that an image-enhanced pixel data block is obtained. Meanwhile, the weighting coefficient calculating module 12 and the accumulating module 13 start to process a next reference window 21 and a next pixel data block 211. General speaking, the normalizing may be implemented by division.

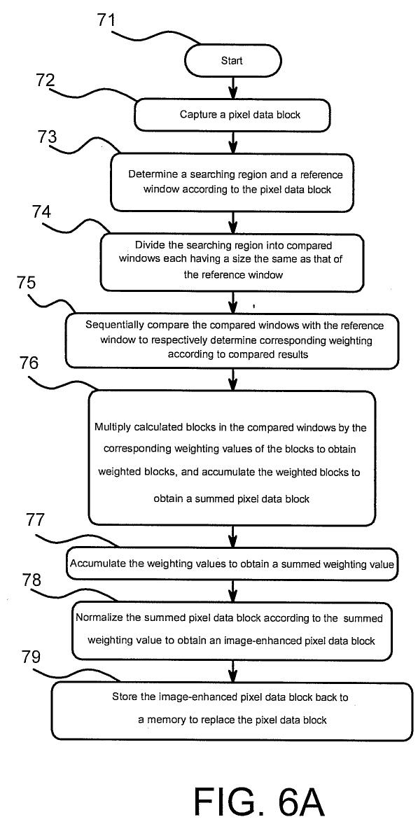

FIG. 5 is a detailed circuit diagram showing the apparatus for enhancing the digital image according to the embodiment of the invention. Referring to FIG. 5, the weighting coefficient calculating module 12 of this embodiment includes a reference window capturing module 501, a compared window capturing module 502 and a weighting coefficient calculating unit 503. The accumulating module 13 includes a block separating module 504 and an accumulating unit 505. In addition, the apparatus further includes an input module 506, an output module 507 and a main control module 508. The connection relationship of this circuit is illustrated in FIG. 5. The input module 506 is mainly for storing the inputted image signal and the captured image data to the memory 11. Generally speaking, when this apparatus is for processing the dynamic image, the memory 11 may be a line buffer. If the originally inputted frame image is YCbCr-422, the input module 506 can down-sample each frame image to the YCbCr-420 format and stores the YCbCr-420 format to the line buffer 11.

The output module 507 captures the image-enhanced data stored in the memory 11, and transfers the YCbCr-420 to the YCbCr-422 signal format. The reference window capturing module 501 captures the reference window and places the reference window in its internal register. The compared window capturing module 502 sequentially captures the compared windows CBK in the fixed range and places the compared windows CBK in its internal register. The weighting coefficient calculating unit 503 compares the reference window with the compared window, and obtains the weighting value according to the similarity between the reference window and the compared window. The similarity between two blocks is typically obtained by directly calculating an absolute value between corresponding pixels in the two blocks. In addition, all the pixel differences in the blocks are summated to obtain an assertion value. The lower assertion value represents the higher similarity between the two blocks. The weighting coefficient calculating unit 503 may be configured as a look-up table to output the weighting value according to the assertion value.

The block separating module 504 captures the weighted block WB from the internal register of the compared window capturing module 502. The accumulating unit 505 captures the weighted block WB from the block separating module 504. In addition, the weighting value obtained by the weighting coefficient calculating unit 503 is multiplied by the weighted block WB to obtain a product, and the products are accumulated to obtain a summed pixel data block. Finally, the averaging module 14 normalizes the summed pixel data block according to the summed weighting value to obtain the image-enhanced pixel data block. Thereafter, the image-enhanced pixel data block is stored back to the memory 11 to replace the original pixel data block.

The main control module 508 controls the operation timings of the reference window capturing module 501, the compared window capturing module 502, the weighting coefficient calculating unit 503, the block separating module 504, the accumulating unit 505 and the averaging module 14. That is, the modules 502, 503, 504, 505 and 14 may operate in a pipelining manner through the main control module 508. For example, when the accumulating unit 505 is operating, the compared window capturing module 502 can update the next compared window to be compared, and the weighting coefficient calculating unit 503 may also start to calculate the next weighting value.

As can be seen from the above-mentioned embodiment, this embodiment achieves the image enhancing algorithm in a block outputting manner. The old pixel data block is replaced with the generated image-enhanced pixel data block in the prior art embodiment in order to reduce the size of the memory. However, the replacement is made by outputting with the pixel serving as one unit. When the noise is larger, the noise eliminating effect is greatly influenced, and the effect is poor than that of the embodiment of the invention.

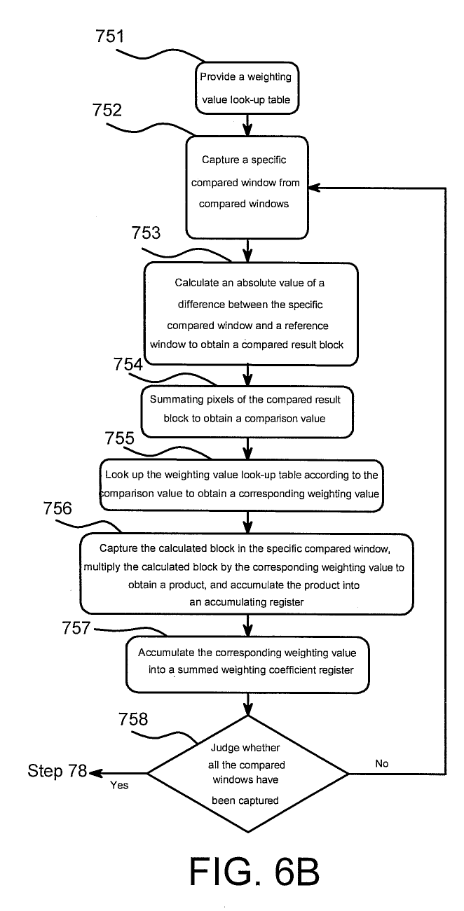

The above-mentioned embodiment may be concluded to have a flow chart for showing a method for enhancing the digital image. FIG. 6A is a flow chart showing the method for enhancing the digital image according to the embodiment of the invention.

In step 71, the method starts.

In step 72, a pixel data block is captured.

In step 73, a searching region and a reference window are determined according to this pixel data block. For example, the searching region and the reference window may be determined with the pixel data block serving as a center. However, one of ordinary skill in the art may understand that the searching region and the reference window may be determined according a region including the pixel data block.

In step 74, the searching region is divided into a plurality of compared windows each having a size the same as a size of the reference window, as shown in FIG. 4, for example.

In step 75, the compared windows are sequentially compared with the reference window, and corresponding weighting values are respectively determined according to compared results.

In step 76, the calculated blocks in the compared windows are multiplied by the corresponding weighting values of the block to obtain a plurality of weighted blocks, and the weighted blocks are accumulated to obtain a summed pixel data block. This step is the same as the Equation 1 and the description thereof, so detailed descriptions thereof will be omitted.

In step 77, the weighting values are accumulated to obtain a summed weighting value.

The steps 75 to 77 may be decomposed into the following sub-steps, which will be described with reference to FIG. 6B.

In step 751, a weighting value look-up table is provided.

In step 752, a specific compared window is captured from the compared windows.

In step 753, an absolute value of a difference between the specific compared window and the reference window is calculated to obtain a compared result block.

In step 754, pixels of the compared result block are summated to obtain a comparison value.

In step 755, the weighting value look-up table is looked up according to the comparison value to obtain a corresponding weighting value.

In step 756, the calculated block in the specific compared window is captured and multiplied by the corresponding weighting value to obtain a product, which is accumulated into an accumulating register.

In step 757, the corresponding weighting values are accumulated into a summed weighting coefficient register.

In step 758, it is judged whether all the compared windows have been captured or not. If yes, step 78 is performed. If not, the procedure goes back to the step 752 until the corresponding weighting values of all the compared windows have been found.

In the step 78, the summed pixel data block is normalized according to the summed weighting value to obtain an image-enhanced pixel data block. For example, the summed pixel data block is divided by the summed weighting value to obtain the image-enhanced pixel data block.

In step 79, the image-enhanced pixel data block is stored back to the memory to replace the pixel data block, and the procedure goes back to the step 71 until the noise of the image has been removed.

In summary, the spirit of the invention is to provide the image enhancing algorithm with the block serving as one unit. Thus, the invention has the following advantages.

First, compared with the prior art, in which the data is outputted with the pixel serving as one unit, the invention has the data throughput speed, which is several times that of the prior art, per unit time.

Second, the invention has almost the same noise suppressing ability as the prior art having the algorithm with the pixel serving as one unit.

In addition, the original pixel data block is replaced with the image-enhanced pixel data block in the embodiment of the invention. So, the invention has the following advantages as compared with the prior art.

First, the memory size is reduced and the hardware cost is lowered.

Second, the better noise eliminating effect can be obtained as compared with the prior art having the algorithm with the pixel serving as one unit.

While the invention has been described by way of examples and in terms of preferred embodiments, it is to be understood that the invention is not limited thereto. To the contrary, it is intended to cover various modifications. Therefore, the scope of the appended claims should be accorded the broadest interpretation so as to encompass all such modifications.

What is claimed is:

1. A method for enhancing a digital image, the method comprising the steps of:
capturing a pixel data block;
determining a searching region and a reference window according to the pixel data block;
dividing the searching region into a plurality of compared windows each having a size the same as a size of the reference window;
sequentially comparing the compared windows with the reference window to respectively determine corresponding weighting values according to compared results;
multiplying calculated blocks in the compared windows by the corresponding weighting values of the blocks to obtain a plurality of weighted blocks, wherein a position of each of the calculated blocks in the compared windows are the same as a position of the pixel data block in the reference window;
accumulating the weighted blocks to obtain a summed pixel data block;
accumulating the weighting values to obtain a summed weighting value; and
normalizing the summed pixel data block according to the summed weighting value to obtain an image-enhanced pixel data block.

2. The method according to claim 1, wherein the obtained image-enhanced pixel data block has a size smaller than or equal to the reference window.

3. The method according to claim 1, wherein the pixel data block is captured from a memory, and the step of capturing the pixel data block comprises:
storing the obtained image-enhanced pixel data block to the memory to replace the pixel data block.

4. The method according to claim 3, wherein the memory is a linear buffer memory.

5. The method according to claim 3, wherein the searching region comprises pixels (1,1) to (M,N), the reference window comprises X pixels×Y pixels, and the method further comprises the step of:
dividing the searching region into the compared windows, wherein a range of an (i,j)^{th} compared window is a window enclosed by (i,j), (i+X,j), (i,j+Y) and (i+X,j+Y), i, j, X, Y, M and N are natural numbers, and i+X<=M, j+Y<=N.

6. The method according to claim 5, wherein i=kr+a, a, k and r are integers greater than or equal to 0, a is a displacement constant, k<=M−X, r is a horizontal skipping constant, and r<M−X.

7. The method according to claim 5, wherein j=ps+b, b, p and s are integers greater than or equal to 0, b is a displacement constant, p<=N−Y, s is a vertical skipping constant, and s<N−Y.

8. The method according to claim 1, wherein the step of sequentially comparing the compared windows with the reference window to determine the corresponding weighting values according to compared results comprises the sub-steps of:
providing a weighting value look-up table;
(a) capturing a specific compared window from the compared windows;
(b) calculating an absolute value of a difference between the specific compared window and the reference window to obtain a compared result block;
(c) summating pixels in the compared result block to obtain a comparison value;
(d) looking up the weighting value look-up table according to the comparison value to obtain a corresponding weighting value; and
(e) rejecting the specific compared window from the compared windows, and going back to the sub-step (a) until the corresponding weighting values are found from all of the compared windows.

9. The method according to claim 1, wherein the searching region is located in former “a” frames, and “a” is a natural number.

10. The method according to claim 1, wherein the searching region is located in latter “a” frames, and “a” is a natural number.

11. The method according to claim 1, wherein the step of normalizing the summed pixel data block according to the summed weighting value to obtain the image-enhanced pixel data block comprises:
dividing the summed pixel data block according to the summed weighting value to obtain the image-enhanced pixel data block.

12. An apparatus for enhancing a digital image, the apparatus comprising:
a memory for storing a image data;
a weighting coefficient calculating module, coupled to the memory, for capturing a reference window from the memory, wherein the reference window comprises a pixel data block, and sequentially captures a plurality of compared windows from the memory in a fixed range of the reference window with a position of the graphic data serving as a center, and sequentially comparing the compared windows with the reference window to correspondingly determine a plurality of weighting values of the compared windows;
an accumulating module, coupled to the weighting coefficient calculating module, for accumulating products, which are obtained by multiplying weighted blocks in the captured compared window by the corresponding weighting values, to obtain a summed pixel data block, wherein a position of each of the weighted blocks in the compared windows is the same as a position of the pixel data block in the reference window; and
an averaging module, coupled to the accumulating module and the weighting coefficient calculating module, for accumulating the weighting values to obtain a summed weighting value, and normalizing the summed pixel data block according to the summed weighting value to obtain an image-enhanced pixel data block.

13. The apparatus according to claim 12, wherein the weighting coefficient calculating module comprises:
a reference window capturing module, coupled to the memory, for capturing the reference window;
a compared window capturing module, coupled to the memory, for sequentially capturing the compared windows in the fixed range; and
a weighting coefficient calculating unit, coupled to the reference window capturing module and the compared window capturing module, for comparing the reference window with the compared windows to obtain the weighting values.

14. The apparatus according to claim 12, wherein the accumulating module comprises:
a block separating module, coupled to the weighting coefficient calculating module, for separating the weighted blocks from the captured compared windows; and
an accumulating unit, coupled to the block separating module, for accumulating the products, which are obtained by respectively multiplying the weighted blocks by the corresponding weighting values, to obtain the summed pixel data block.

15. The apparatus according to claim 12, wherein the averaging module is further coupled to the memory and is for storing the obtained image-enhanced pixel data block to the memory to replace the pixel data block.

16. The apparatus according to claim 12, further comprising:
an input module, coupled to the memory, for capturing the image data from inputted image signal and outputting the image data to the memory.

17. The apparatus according to claim 12, further comprising:
an output module, coupled to the memory, for capturing the image-enhanced pixel data block stored in the memory and transferring the image-enhanced pixel data block into a designated output signal format.

18. The apparatus according to claim 12, further comprising:
a main control module for controlling operation timings of the weighting coefficient calculating module, the accumulating module and the averaging module.

19. The apparatus according to claim 12, wherein the memory is a line buffer.

20. The apparatus according to claim 12, wherein the averaging module is for dividing the summed pixel data block according to the summed weighting value to obtain the image-enhanced pixel data block.
